(19) United States
(12) Patent Application Publication
(10) Pub. No.: US 2018/0341106 A1
(43) Pub. Date: Nov. 29, 2018

(54) METHOD AND SYSTEM FOR AUTOMATICALLY CONTROLLING LIGHTING OF A PERSON VIA INCIDENT LIGHT RADIATION

(71) Applicant: STMicroelectronics (Grand Ouest) SAS, Delarue (FR)

(72) Inventor: Vincent ABRIOU, Saint Georges du Bois (FR)

(73) Assignee: STMicroelectronics (Grand Ouest) SAS, Delarue (FR)

(21) Appl. No.: 15/984,719

(22) Filed: May 21, 2018

(30) Foreign Application Priority Data
May 26, 2017 (FR) 1754657

(51) Int. Cl. G02B 27/00; H05B 33/08; G06F 3/01

(52) U.S. Cl. CPC G02B 27/0093; G06F 3/013; H05B 33/089; H05B 33/0854

(57) ABSTRACT

The lighting of a person via incident light radiation is controlled to address dazzling. The light radiation originates from a source of light and passes through a medium of variable and controllable opacity. The position of the source of light relative to the person can vary. A zone of the eyes of the person and a position of the zone of the eyes relative to the medium is detected. A incidence of dazzling of the zone of the eyes is detected. In response to the detection, the direction of incidence of the light radiation is determined. From this determination, from the position of the zone of the eyes, a region of said medium is identified that has a projection on the face of the person which includes said zone of the eyes. The opacity of the region of the medium is then modified in a controlled manner to preclude dazzling.

### PRIORITY CLAIM

This application claims the priority benefit of French Application for Patent No. 1754657, filed on May 26, 2017, the disclosure of which is hereby incorporated by reference in its entirety to the maximum extent allowable by law.

### TECHNICAL FIELD

Embodiments relate to control systems, and more particularly the control systems configured to automatically control the lighting of a person via incident light radiation coming from a source of light, such as to prevent the person from being dazzled by the source of light.

### BACKGROUND

Generally, it is often annoying for a person to be directly lit or dazzled by a particularly strong source of light, for example the sun or a high power incandescent lamp, when this person travels by car or by train or when this person works in an office that may be lit by such a source of light.

To prevent and remove possible dazzling, sun visors, over-tinted glass panes, curtains or lampshades are generally used such as to position a more or less opaque intermediate screen between the person and the source of light.

However, this always requires manual positioning of this intermediate screen which is generally oversized in order to not let through too much light. Therefore, the size of the screen is not always suitable for the actual requirement of the person.

Furthermore, the position of this intermediate screen is not generally suitable with respect to the person and the source of light since the relative position between the person and the source of light can be modified at any moment. A manual readjustment of this intermediate screen such as to readapt the variation in the relative position is consequently necessary or indispensable.

Thus, there is a requirement to propose a technical solution for automatically and adaptively controlling the lighting of a person, via incident light radiation coming from a source of light, with no manual positioning of a more or less opaque intermediate screen between the source of light and the person.

### SUMMARY

According to one aspect, automatically controlling lighting of a person via incident light radiation is proposed, the light radiation passing through a medium of variable and controllable opacity and coming from a source of light, the position of which relative to said person can vary.

The method comprises: detecting a zone of the eyes of the person and the position of the zone of the eyes relative to said medium; possibly detecting dazzling of the zone of the eyes, and, in the case of such a detection, determining the direction of incidence of the light radiation; determining, from the direction of incidence of the light radiation and from the position of the zone of the eyes, a region of said medium, the projection of which on the face of the person includes said zone of the eyes; and modifying, in a controlled manner, the opacity of said region of the medium.

Dazzling is typically lighting having a luminous intensity greater than a chosen threshold. A person skilled in the art can determine this threshold according to the envisaged use.

Such a method advantageously allows for detecting if there is dazzling of the person and the direction from which the dazzling originates, i.e. the position of the source of light involved with respect to the person, and for controlling the opacity of the region of the medium located between the person and the source of light such as to remove the dazzle.

Said region of the medium advantageously has a position and a dimension that are suitable for covering at least the zone of the eyes. This determination of said region of the medium is advantageously carried out constantly such that the dazzling of the person is removed even if the relative position between the person and the source of light varies.

The possible detection of the dazzling of the zone of the eyes can, for example, comprise a definition of a comfort zone including the zone of the eyes and an analysis of shadows on the comfort zone.

The comfort zone can, for example, encompass at least part of the face and be centered on the zone of the eyes.

According to one implementation method, the direction of incidence of the light radiation is determined from said analysis of shadows.

According to another implementation method, when there is no dazzling of the zone of the eyes, the medium is optically transparent.

By way of non-limiting example, the size and the shape of the comfort zone and of said region of the medium can be configurable.

According to yet another implementation method, said medium is coupled with a glass pane.

The medium can, for example, include a film of organic light-emitting diodes (OLED).

In an alternative, the medium can, for example, be a transparent glass screen of the “crystal frame” type (“Crystal Frame Display”).

According to an implementation method, the zone of the eyes and the position thereof are detected using at least one vision camera arranged at a location having a known position with respect to said medium.

It is possible, for example, to detect the zone of the eyes and the position thereof using a single vision camera of the time-of-flight type arranged at a location having a known position with respect to said medium.

According to another aspect, a control system is proposed, which is configured to automatically control the lighting of a person via incident light radiation.

The system comprises: a medium of variable and controllable opacity, said medium configured to be crossed by the light radiation coming from a source of light, the position of which relative to said person can vary; a detection circuit configured to detect a zone of the eyes of the person and the position of the zone of the eyes relative to said medium; a processing circuit configured to detect possible dazzling of the zone of the eyes, and when there is dazzling of the zone of the eyes, determining, from the direction of incidence of the light radiation and from the position of the zone of the eyes, a region of said medium, the projection of which on the face of the person includes said zone of the eyes, and a command circuit configured to modify the opacity of said region of the medium.

The processing circuit can, for example, be configured to detect the possible dazzling of the zone of the eyes, by defining a comfort zone including the zone of the eyes and analyzing the shadows on the comfort zone.

The comfort zone can, for example, encompass at least part of the face and be centered on the zone of the eyes.

By way of indication, the processing circuit is further configured to determine the direction of incidence of the light radiation from the analysis of shadows.

When there is no dazzling of the zone of the eyes, the medium can be configured to be optically transparent.

By way of non-limiting example, the size and the shape of the comfort zone and of said region of the medium can be configurable.

According to an embodiment, the medium is configured to be coupled with a glass pane.

According to another embodiment, the medium includes a film of organic light-emitting diodes.

According to yet another embodiment, the medium is a transparent glass screen of the “crystal frame” type (“Crystal Frame Display”).

The detection circuit can, for example, include at least one vision camera arranged at a location having a known position with respect to said medium.

According to an embodiment, the detection circuit can, for example, include a single vision camera of the time-of-flight type arranged at a location having a known position with respect to said medium.

According to another aspect, a compartment is proposed which includes a system as defined above and configured to receive said person.

According to another aspect, a means of transport is proposed, such as a car, a plane, a train or a boat, comprising a compartment as defined above.

According to yet another aspect, a building is proposed which comprises at least one compartment, for example, such as an office or a room as defined above.

### BRIEF DESCRIPTION OF THE DRAWINGS

Other advantages and features of the invention will emerge upon examining the detailed description of implementation methods and embodiments, which are in no way limiting, and the appended drawings, wherein:

FIG. 1 schematically illustrates a compartment supporting embodiments for protecting against dazzling;

FIG. 2 is a control system block diagram;

FIG. 3 shows an image taken;

FIG. 4 is a table illustration the results of calculations;

FIG. 5 illustrates the comfort zone;

FIG. 6 illustrates a non-operational case; and

FIG. 7 illustrates an operational case.

### DETAILED DESCRIPTION

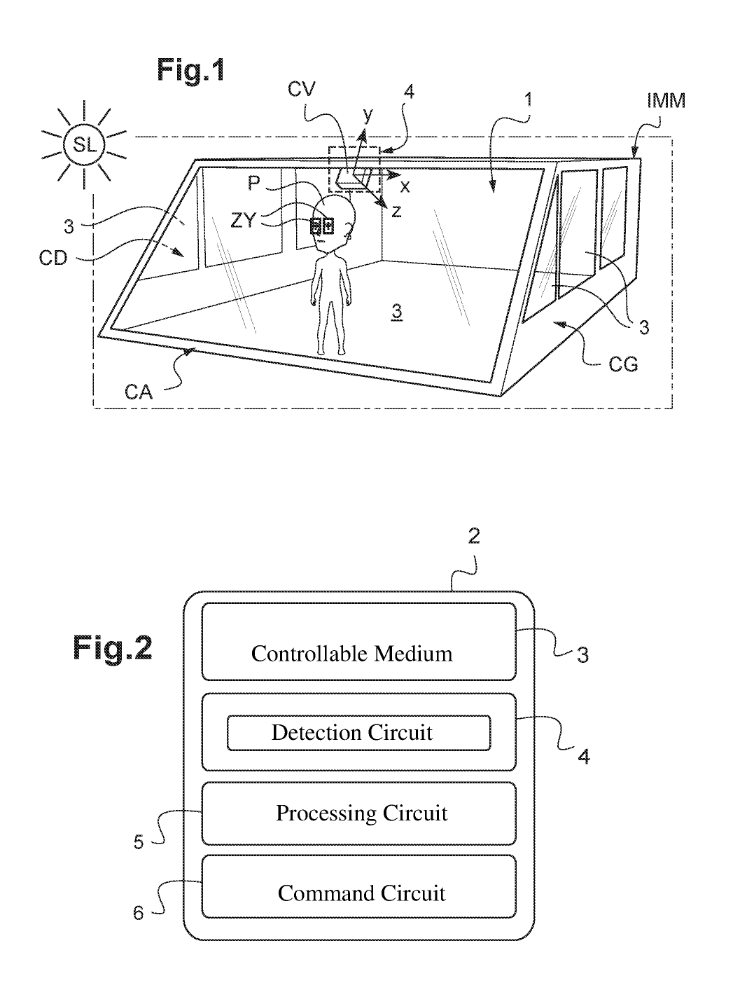

In FIG. 1, the reference 1 refers to a building IMM, in this case comprising, for example, at least one compartment 1 such as an office or a room, for example. For purposes of simplification, a single compartment 1 is illustrated in FIG. 1.

The compartment 1 can comprise a plurality of glass panes, in this case, for example, arranged on the three sides of the compartment 1: the front side CA, the left side CG, and the right side CD.

All of the glass panes are transparent by default such as to allow the penetration, into the compartment 1, of the light radiation coming from a source of light SL such as the sun or an outside lamppost using a high power incandescent lamp, for example greater than 100 Watts, arranged outside the compartment 1.

To control the lighting of a person present in the compartment 1, via light radiation coming from the source of light SL, the compartment 1 includes a control system 2, as illustrated in FIG. 2.

The system 2 firstly comprises a medium 3, the opacity of which is controllable such as to be able to take various values of opacity as a percentage between two limit values, for example between 0% and 100%. A first limit value corresponds, for example, to the optical transparency of the medium 3. A second limit value corresponds, for example, to the total opacity of the medium 3.

For this purpose, the medium 3 can comprise a film of organic light-emitting diodes commonly known to a person skilled in the art by the acronym OLED (Organic Light-Emitting Diode).

This OLED film is characterized in that it is advantageously transparent in standby mode or off mode, and flexible such as to allow it to be coupled in this case, for example, with the glass panes of the compartment 1, for example by sticking.

As a result, it is possible to create with the medium 3, between the source of light SL and the person P, a screen having an opacity that can be controlled by commanding the opacity of the medium 3 of the system 2 (FIG. 2).

In an alternative, the medium 3 can, for example, be a transparent glass screen of the crystal frame CC type (“Crystal Frame Display”) and replace a glass pane.

When the medium 3 of the “Crystal Frame Display” CC type is not illuminated, it precisely resembles a transparent glass pane.

During the operation thereof, it is possible to control the opacity and the color of each pixel of the medium 3 of the crystal frame CC type such as to illustrate desired multimedia information.

It is possible to find more information on this medium of the crystal frame CC type by reference to the products of the E-Like Technology Co. LTD, Shenzhen, China (see, for example, www.sz-elike.com/product/detail/CrystalFrame.html).

The system 2 further comprises detection circuit 4 coupled with the medium 3 and configured to detect a zone of the eyes ZY of the person P and the position of the zone of the eyes ZY relative to said medium 3.

The detection circuit 4 can comprise at least one vision camera CV, in this case, for example, a vision camera of the time-of-flight type (ToF) operating on the time-of-flight principle and making it possible to measure a three-dimensional scene (i.e. a distance) in real-time.

For this purpose, the vision camera CV illuminates the scene, in this case the detection space thereof in the compartment 1 and one or more measured objects, in this case the person P via light radiation, and calculates the time that this light radiation takes to make the return journey between the person and the camera CV. The time of flight of this light radiation is directly proportional to the measured distance between the camera CV and the person P.

It should be noted that it is possible to use a set of two vision cameras (not illustrated in the figure for purposes of simplification), for example conventional cameras and not necessarily cameras of the time-of-flight type, in order to photograph the scene in three dimensions such as to detect said distance.

It is assumed hereafter that only one camera CV of the time-of-flight type is used.

By way of indication, the detection circuit 4 can, for example, use the eye detection algorithms (“eye detect algorithms” or gaze tracking algorithms) known to a person skilled in the art in order to track the variation of the positions of the eyes of the person P.

By way of indication, it is possible to mention a simple and effective algorithm as taught by https://goo.gl/Fw6S04 for detecting and tracking the centers of the eyes of the person. See also, Timm, et al., “Accurate Eye Centre Localisation by Means of Gradients,” P. VISAPP 2011—Proceedings of the Sixth International Conference on Computer Vision Theory and Applications, Vilamoura, Algarve, Portugal, 5-7 March, 2011.

As illustrated in FIG. 1, the camera CV is, for example, arranged at the ceiling of the compartment 1 in proximity to the front-side CA wall such as to have a detection space that covers the majority of the compartment 1.

It should be noted that the vision camera CV is arranged at a location having a known position with respect to the medium 3. Thus, the vision camera CV can calculate coordinates of the person P and of the medium 3 of the system 2 while using a same system of coordinates with axes X, Y, and Z, as illustrated in FIG. 1.

The detection space of the detection circuit 4, in other words the field of vision of the vision camera CV is fixed once the position of the camera CV is fixed.

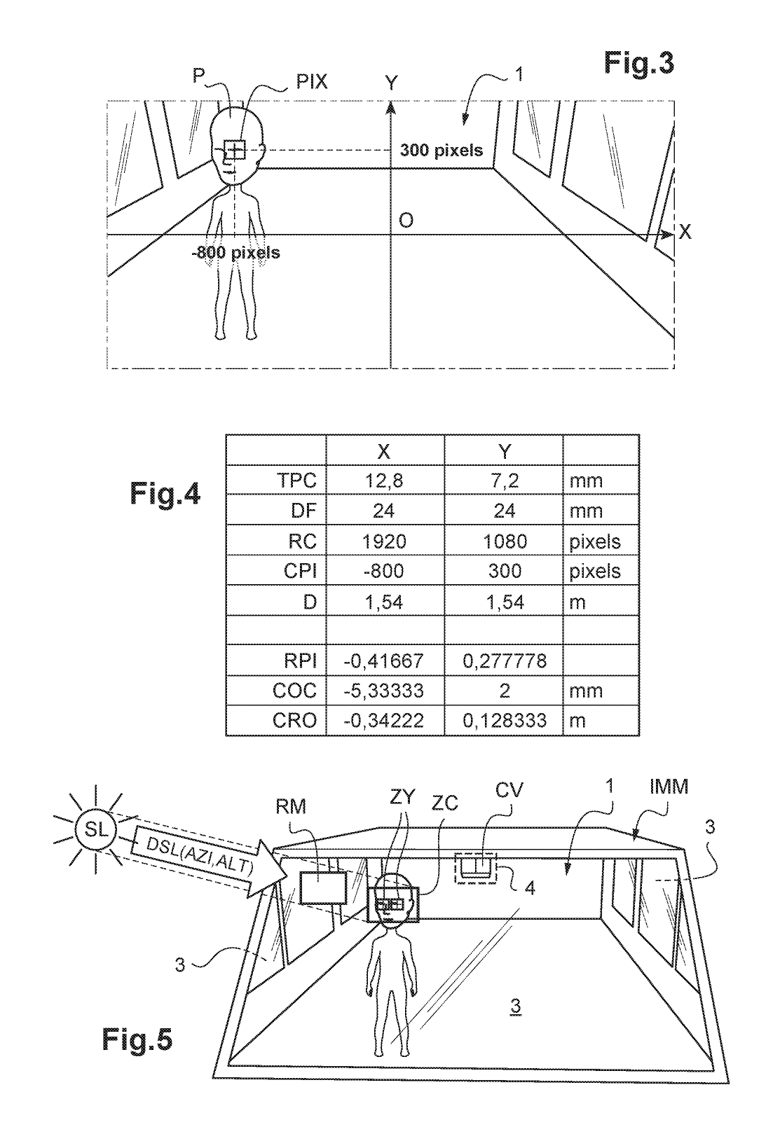

Reference is now made to FIG. 3 and to the table of FIG. 4 in order to illustrate an example of calculating coordinates of a person detected by the camera CV of the detection circuit 4.

FIG. 3 indeed shows an image taken by the vision camera CV and covering the detection space of the vision camera CV.

The center of the image represents the origin O of the coordinate system that is illustrated in FIG. 3. This origin O corresponds to the position of the camera CV.

Each image pixel illustrated in FIG. 3 corresponds to an element detected by a corresponding active pixel in a sensor, for example a CMOS sensor, of the camera CV.

By way of example, the physical size of the sensor TPC of the camera CV is 12.8 mm×7.2 mm and the resolution RC of the sensor is 1920×1080 pixels.

As described above, each active pixel of the sensor of the camera CV can detect a distance D between this active pixel and the element detected via the light radiation emitted by this active pixel.

In the example illustrated in FIG. 3, a pixel PIX detects a part of the left eye of the person P. The distance D between the pixel PIX and the part of the left eye is equal to 1.54 m.

The coordinates of this pixel PIX in the image CPI are −800 pixels on the axis X and 300 pixels on the axis Y. The focal length DF of the camera is 24 mm.

Once all the above data has been obtained, it is possible to calculate an image pixel ratio RPI (RPI=CPI/RC), coordinates of the object detected in the sensor COC (COC=TPC*RPI), and actual coordinates of the object CRO with respect to the origin O of the system of coordinates (CRO=(D/DF)*COC). The results of these calculations are illustrated respectively in the table of FIG. 4.

Consequently, the detection circuit 4 can precisely detect, in the detection space of the vision camera CV, the coordinates of all elements with respect to the position of the camera CV. Since the position of the camera CV is known with respect to the medium 3, the position of the medium 3 is also known by the detection circuit 4.

The system 2 further comprises processing circuit 5 configured to analyze images captured by the detection circuit 4.

For this purpose, the processing circuit 5 are configured to define a comfort zone ZC encompassing at least part of the face of the person P and being centered on the zone of the eyes ZY.

By way of non-limiting example, the comfort zone ZC includes a third of the total surface of the face of the person P.

It should be noted that the comfort zone ZC can also be detected directly by the detection circuit 4 by using other algorithms such as face detection algorithms (http://cmusatyalab.github.io/openface).

The size and the shape of the comfort zone ZC are not limited by those illustrated in FIG. 5. By contrast, they can be configured such as to best contribute to the effectiveness and to the speed of the system 2.

To provide a better performance, particularly a detection of the zone of the eyes ZY undertaken by the detection circuit 4 and real-time tracking of this detection, the vision camera CV preferably has a number of images (frames) per second, at least 60 images per second.

By way of example, the processing circuit 5 can be at least partially implemented in the detection circuit 4, for example as software or using specific circuits.

The processing circuit 5 are further configured to analyze shadows on the comfort zone ZC and particularly levels of exposure and transitions of shades detected in the comfort zone ZC such as to determine if the person P is dazzled by the source of light SL. Dazzling is characterized by a lighting of the zone of the eyes ZY, the light intensity of which is greater than a chosen threshold.

If dazzling of the person is determined, the processing circuit 5 is further configured to calculate, depending on the analysis of the shadows detected in the comfort zone ZC, the direction DSL of incidence of the light radiation coming from the source of light SL, and which dazzles the person P.

It should be noted that the source of light SL in this case is, for example, an outside source of light SL such as the sun, which source is illustrated in FIG. 1.

For example, it is possible to use an algorithm for detecting shadows and the direction of the sun (goo.gl/QFCXER, Scott Wehrwein, Kavita Bala, Noah Snavely, Cornell University) to calculate the direction DSL of such a source of light SL with respect to the person P.

The result of this calculation makes it possible to establish, in real-time, the azimuth AZI and the altitude ALT of the source of light SL with respect to the person P (FIG. 5).

Moreover, the processing circuit 5 is configured to determine, from the direction DSL and from the position of the zone of the eyes ZY, a region RM of the medium 3, the projection of which on the face of the person P includes the zone of the eyes ZY.

The system 2 further includes a command circuit 6 configured to manage the medium 3 such as to control the opacity of the region of the medium RM.

The command circuit 6 is coupled between the processing circuit 5 and the medium 3, and implemented, for example, as software or using specific circuits.

It should be noted that a person skilled in the art will be able to adjust the level of the opacity of the region of the medium such as to adapt it to each circumstance of use. Thus, it is possible, in some uses, such as for example driving a means of transport, to set an opacity limit such that the driver can continue to see the outside environment in complete safety.

Said region of the medium RM thus forms a more or less opaque intermediate layer positioned between the source of light SL and the person P such as to control the lighting of the person via the light radiation coming from the source of light SL and to remove the possible dazzling of the person P.

The shape of said region of the medium RM is advantageously configurable. For example, it is possible to have a rectangular region RM, an oval region RM or a region RM including several sub-regions with, for example, more complex shapes as long as the projection of said region RM covers the zone of the eyes ZY.

The size of said region RM can vary, for example, depending on the direction DSL, the detected zone of the eyes ZY and/or depending on the configuration of the system 2. It is, however, preferable that the projection of the region RM is not too small with respect to the zone of the eyes ZY.

In order to better control the lighting of the person P, it is preferable that the duration for controlling said region of the medium RM, in other words the response time of the medium 3, does not exceed 16 ms. The processing circuit 5 are, in this respect, advantageously sufficiently powerful to finish the calculations of the direction DSL of incidence of the light radiation coming from the source of light SL and of the region of the medium RM between two consecutive takes of the image of the vision camera CV.

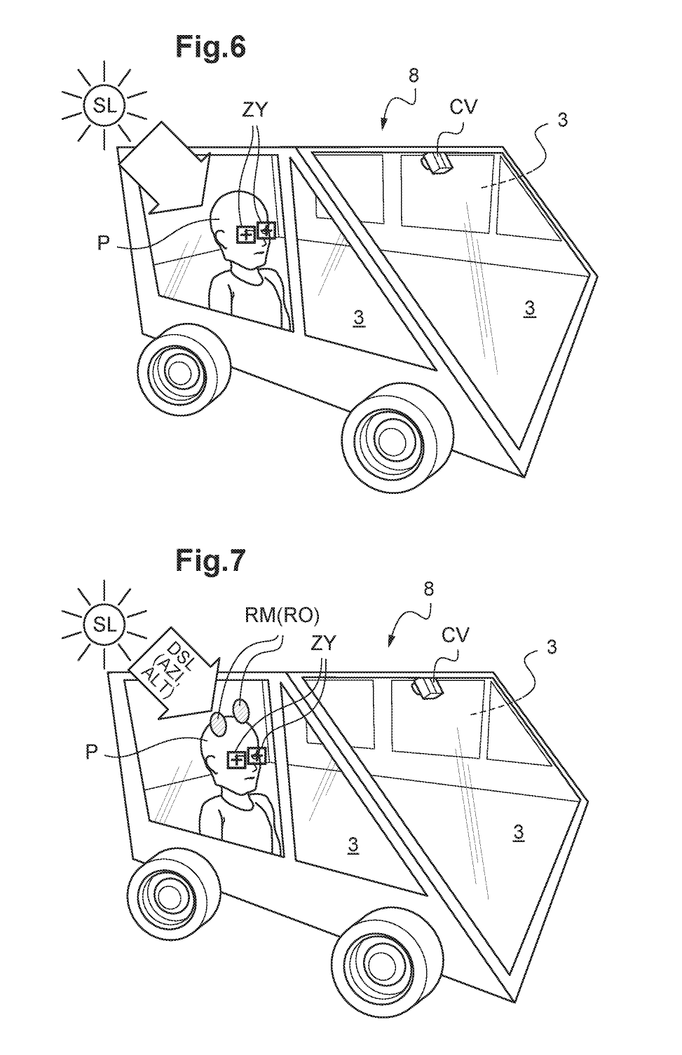

FIGS. 6 and 7 illustrate other examples of the system 2 which are incorporated in a means of transport 8, in this case, for example, a car 8.

The operation of the system 2 implemented in the car 8 is the same as that of the system 2 implemented in the compartment 1 of the building IMM (FIG. 1) with the exception that the command circuit 6 is advantageously configured to modify the percentage opacity of the region RM such that it cannot exceed a threshold, for example 30%, for reasons of road safety, particularly for the driver. It could also be envisaged to remove this threshold for the rear passengers.

Moreover, the region of the medium RM can, for example, be limited to a certain part of the medium 3 such as to avoid having the region of the medium 3 in the middle of the field of vision of the driver.

The glass panes of the car 8 can be provided with the medium 3, for example when the medium 3 is an OLED film, or be completely replaced with the medium 3 when the latter is, for example, of the “Crystal Frame Display” CC type and the camera CV is fixed in the compartment 1 of the car 8 such as to detect the dazzling of the person P, to calculate the direction DSL of the source of light and to determine the region of the medium RM in order to remove the possible dazzling of the person P.

FIG. 6 illustrates a case where the system 2 is not operating. It is noted that the zone of the eyes ZY of the person P received in the car 8 is dazzled by the outside source of light SL.

FIG. 7 illustrates another case where the system 2 operates. The direction DSL of the source of light is calculated and the opacity of the region of the medium RM including two oval sub-regions RO of the medium 3 is controlled. These oval sub-regions RO, the projections of which cover the zone of the eyes ZY of the person P, improve the comfort of the person P and remove the possible dazzling of the person P.

1. A method of automatically controlling lighting of a person via incident light radiation, said incident light radiation passing through a medium of variable and controllable opacity and coming from a source of light, wherein a position of the source of light relative to said person can vary, the method comprising the following steps:
detecting a zone of the eyes of the person and a position of the zone of the eyes relative to said medium;
detecting whether dazzling of the zone of the eyes exists, wherein detecting whether dazzling of the zone of the eyes exists comprises defining a comfort zone including the zone of the eyes and analyzing shadows on the comfort zone; and
if such a detection is made, then:
determining a direction of incidence of the incident light radiation;
determining, from the direction of incidence of the incident light radiation and from the position of the zone of the eyes, a region of said medium having a projection which on the face of the person includes said zone of the eyes, and
modifying, in a controlled manner, the opacity of said region of the medium.

2. The method according to claim 1, wherein the comfort zone encompasses at least part of the face and is centered on the zone of the eyes.

3. The method according to claim 1, further comprising determining the direction of incidence of the incident light radiation from said analysis of shadows.

4. The method according to claim 1, further comprising controlling the medium to be optically transparent when there is no detected dazzling of the zone of the eyes.

5. The method according to claim 1, wherein a size and shape of the comfort zone is configurable and wherein a size and shape of said region of the medium is configurable.

6. The method according to claim 1, wherein said medium is coupled with a glass pane.

7. The method according to claim 1, wherein the medium includes a film of organic light-emitting diodes.

8. The method according to claim 1, wherein the medium is a transparent glass screen of the crystal frame type.

9. The method according to claim 1, further comprising detecting the zone of the eyes and the position of the zone of the eyes using at least one vision camera arranged at a location having a known position with respect to said medium.

10. The method according to claim 9, wherein the at least one vision camera is a single vision camera of the time-of-flight type arranged at a location having a known position with respect to said medium.

11. A control system configured to automatically control the lighting of a person via incident light radiation, comprising:
a medium of variable and controllable opacity, said medium configured to be crossed by the light radiation coming from a source of light, wherein a position of the source of light relative to said person can vary;
a detection circuit configured to detect a zone of the eyes of the person and the position of the zone of the eyes relative to said medium;
a processing circuit configured to detect dazzling of the zone of the eyes, and in response to such a detection to: determine, from a direction of incidence of the light radiation and from the position of the zone of the eyes, a region of said medium having a projection of which on the face of the person includes said zone of the eyes; and
a command circuit configured to modify the opacity of said region of the medium; wherein the processing circuit is configured to detect dazzling of the zone of the eyes by defining a comfort zone including the zone of the eyes and analyzing shadows on the comfort zone.

12. The system according to claim 11, wherein the comfort zone encompasses at least part of the face and is centered on the zone of the eyes.

13. The system according to claim 11, wherein the processing circuit is further configured to determine the direction of incidence of the light radiation from the analysis of shadows.

14. The system according to claim 11, wherein the command circuit is further configured to modify the opacity of said medium to be optically transparent when there is no detected dazzling of the zone of the eyes.

15. The system according to claim 11, wherein a size and a shape of the comfort zone is configurable and wherein a size and a shape of said region of the medium is configurable.

16. The system according to any claim 11, wherein the medium is configured to be coupled with a glass pane.

17. The system according to claim 11, wherein the medium includes a film of organic light-emitting diodes.

18. The system according to claim 11, wherein the medium is a transparent glass screen of the crystal frame type.

19. The system according to claim 11, wherein the detection circuit includes at least one vision camera arranged at a location having a known position with respect to said medium.

20. The system according to claim 19, wherein the at least one vision camera is a single vision camera of the time-of-flight type arranged at a location having a known position with respect to said medium.

21. A compartment including a system according to claim 11 and configured to receive said person.

22. The compartment of claim 21, wherein the compartment is part of a transport such as a car, a plane, a train or a boat within which said compartment is located.

23. The compartment of claim 21, wherein the compartment is part of a building within which said compartment is located.
